(19) United States
(12) Patent Application Publication
(10) Pub. No.: US 2004/0044595 A1
(43) Pub. Date: Mar. 4, 2004

(54) Method of daily parts ordering

(76) Inventor: Jacqueline L. Castro, Torrance, CA (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/231,453

(22) Filed: Aug. 30, 2002

(51) Int. Cl. G06F 17/60

(52) U.S. Cl. 705/28

(57) ABSTRACT

A method for daily ordering of parts for one or more parts warehouses, includes, determining a specified part number and available supplier from which to place a daily parts order for the specified part number; obtaining from each warehouse, a total available inventory for the specified part number; preparing a sales forecast for the specified part number, wherein the sales forecast includes one or more months; converting the sales forecast into a running daily forecast covering a specified order point period of time beginning on a predetermined day; generating a total daily order point quantity of units for the specified part number, based on the running daily forecast; and ordering parts, corresponding to the specified part number, from a supplier, wherein the quantity of parts ordered corresponds to the difference between the total daily order point quantity and the total available inventory.

### BACKGROUND OF THE INVENTION

The instant invention is directed to a method for daily ordering of parts. More specifically, it is directed to a method for daily ordering of parts based on a running daily forecast of sales.

Companies which maintain a large quantity of parts on hand need to have a large warehouse or warehouses in order to provide the availability of parts to the consumers. Many companies have multiple parts warehouses in different regions of the country. These parts warehouses are located such that delivery of parts from the parts warehouse to a dealer can be accomplished in a minimum amount of time. For example, in the automobile industry, it is not unusual for a company to have 10 different regional parts warehouses, so each parts warehouse is in reasonable proximity to dealers in its region. This reduces the amount of time necessary for shipping parts from a parts warehouse to the dealer.

Parts suppliers may be located domestically, or they may be located overseas. Not surprisingly, parts that are sourced from overseas suppliers require a larger lead time to be received. For example, if a lead time for receiving parts from a supplier overseas is 1.5 months, to reach a hub, and an additional 0.5 month to reach the parts warehouse, it is then necessary to order parts more than two months before they will be received at the parts warehouse. Additionally in the past, parts were ordered weekly or monthly. Furthermore, suppliers sometimes shipped only weekly or monthly. If the parts were ordered monthly and the suppliers shipped monthly, then it is possible that the parts would need to be ordered 4 months or more before they would be received at a parts warehouse. This requires forecasting of the needs for each parts warehouse 4 months or more in advance. Also, not surprisingly, accurately forecasting the parts needs for a parts warehouse four months in advance is a very difficult task.

Another factor in the parts supply chain is the amount of safety stock required for the parts warehouses to have available. In general, safety stock is required in order to compensate for forecasting errors and for varying market demands. Generally, the longer it takes to obtain a part, the more safety stock that is required to have available. For example, if the lead time for obtaining the part is 3 months, then it would be advisable to have a 3 months supply of safety stock available. Accordingly, the less lead time that is needed to receive the part, the less safety stock is required.

In the current business climate, in which cost cutting is very important, companies, such as automobile manufactures, work very hard to reduce costs. One way to reduce costs in the parts area is to reduce the total available inventory. The total available inventory is that which is on hand (or actually present in the warehouse) plus the inventory “on order”, minus the inventory on “back order”. As mentioned above, reducing lead time will reduce the requirement for inventory. More specifically, taking an example of parts ordered from overseas, instead of ordering parts on a weekly or monthly basis, ordering parts on a daily basis will help to reduce the inventory requirement. If parts are ordered daily, rather than weekly or monthly, then there is no waiting for 6 days if parts are ordered weekly or 29 days if parts are ordered monthly, in order to have the needed parts ordered. Furthermore, if the supplier is organized to ship daily, rather than weekly or monthly, then there can be a reduction in lead time for parts to be ordered. For overseas suppliers that ship parts by ship, the only real way to reduce the lead time is to reduce the time for the supplier to ship the parts, the time for ordering the parts, and the time for shipping the parts to the parts warehouses once they arrive in the country. Another advantage of daily ordering is that it is very responsive to market demands compared with buying parts based solely on a four month forecast.

If parts are ordered daily and shipped daily, this provides for a more constant and smooth flow of parts between the supplier and the parts warehouses rather than when parts are ordered monthly and they are shipped and arrived once a month in large quantities. For example, if a certain part was ordered every month in a certain number, such as 100 units, there may be a lag time waiting for all 100 units to be manufactured and shipped, and accordingly delivered. The supplier would likely wait to manufacture 100 units before shipping. On the other hand, considering the daily ordering of parts, in accordance with the instant invention, instead of ordering 100 units each month, only 3 or 4 units will be ordered every day. This aids the suppliers by enabling them to have smoother and more stabler orders. When the parts arrive, they are in small groups and are easily distributed and put away. A further advantage if the parts are ordered daily is that the supplier can better anticipate the needs of the purchaser. Furthermore, it allows the supplier to prepare his production to better support the purchaser. Because of this stability, the supplier may also be able to shorten his lead time, thereby further reducing inventory costs of the purchaser.

### SUMMARY OF THE INVENTION

The method for daily ordering of parts in accordance with the instant invention is intended to reduce the total available inventory. By reducing the inventory, cost savings are achieved and parts are flowing from the supplier to the warehouses on a daily basis. Furthermore, the inaccuracy of sales forecasts, 4 months or more into the future, is reduced. In this method of daily ordering of parts, a total daily order point quantity is determined. This would be the total available inventory by all warehouses on a predetermined day. If the total available inventory at all the warehouses falls below the total daily order point quantity, then the difference between the total available inventory and the total daily order point quantity is included in a parts order to the supplier. While the total daily order point quantity still uses a 3 to 4 month sales forecast as a factor in its determination, the use of the daily running forecast and daily ordering reduces the amount of error caused by a 3 to 4 month forecast.

A method of daily ordering of parts for one or more parts warehouses includes determining a specified part number and available supplier from which to place a daily parts order for the specified parts number, obtaining from each warehouse a total available inventory for a specified part number, preparing a sales forecast for the specified part number, wherein the sales forecast includes one or more months and converting the sales forecast into a running daily forecast covering a specified order point period beginning on a predetermined day. Once the running daily forecast is obtained, a total daily order point quantity of units for a specified part number is generated, based on the daily forecast. Then a part order is conveyed to the supplier which corresponds to the specified part number and wherein the quantity of parts ordered corresponds to the difference between the total daily order point quantity and the total available inventory.

### BRIEF DESCRIPTION OF THE DRAWINGS

FIG. 1 is a block diagram illustrating a conventional structure for ordering parts;

FIG. 2 is a flowchart illustrating the instant method of daily ordering;

FIG. 3 is a table illustrating the generation of the total daily order point quantity;

FIG. 4 is a block diagram illustrating a structure to be used with the instant method of ordering parts; and

FIG. 5 illustrates alarms conditions generated when ordering parts.

### DETAILED DESCRIPTION OF THE INVENTION

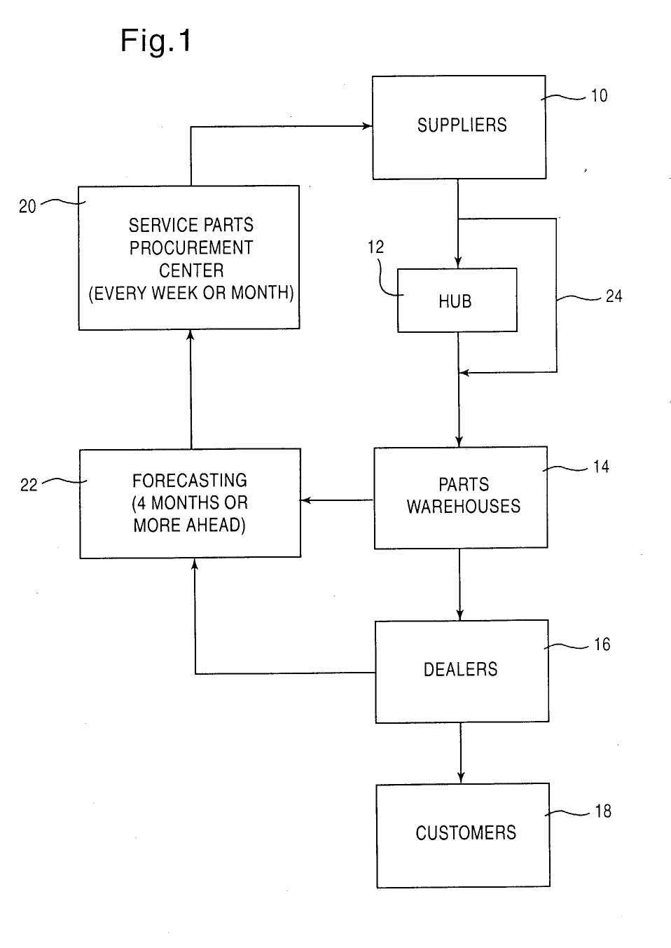

FIG. 1 illustrates a conventional method of ordering parts for supply in warehouses. As illustrated in FIG. 1, suppliers 10 supply parts to hub 12 which in turn supplies parts to parts warehouses 14. Alternatively, suppliers 10 may supply parts directly to parts warehouses 14 as illustrated at arrow 24. Reference numeral 14 represents a single warehouse or a plurality of warehouses. While in most circumstances, companies have a plurality of warehouses located in different parts of the country, it is possible that a single warehouse is part of an ordering system. Warehouses 14 then supply to dealers 16 who sell parts to the ultimate customers 18. While the instant method applies to many types of businesses which require storing parts at parts warehouses for ultimate distribution, in the context of supplying automobile parts, the parts warehouses 14 provide parts to automobile dealers 16 who then provide parts to customers through their own service department, to independent repair shops and for retail sales to other customers. A forecasting process 22, as illustrated here 4 months or more in advance is prepared using information from the parts warehouses 14, the dealers 16, and from many other sources. The service part procurement center 20 considers the forecasting from box 22 and then orders parts for the parts warehouses 14 or for the hub 12 to be distributed to the parts warehouses 14 (every week or every month).

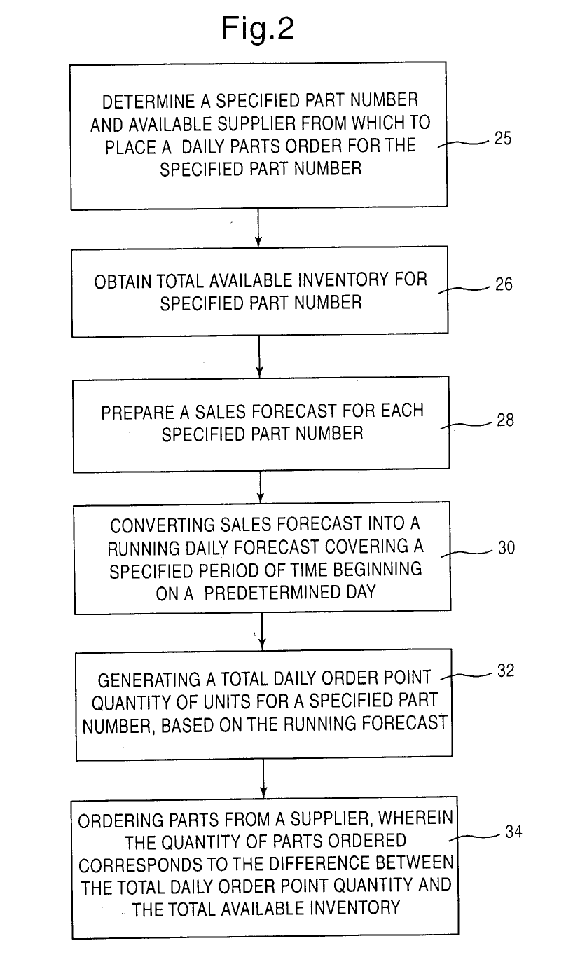

FIG. 2 is a flow chart illustrating a method of the instant invention. Step 25 indicates the determination of a specified part number to be ordered and an available supplier from which to place a daily parts order for the specified part number. Step 26 indicates steps of obtaining total available inventory for a specified part number. In other words, if there is a single warehouse in the system, all of the total available inventory for the specified part number in that warehouse is considered. If there are multiple warehouses in the system, then the total available inventory for a specified part number for all of the warehouses is considered. Step 28 indicates that a sales forecast is prepared for each specified part number. If there multiple part numbers to be considered, then the sales forecast is prepared for each individual part number. A sales forecast is prepared for each month, and usually such forecasts are prepared 3 to 4 months in advance. As noted above, to accurately prepare a sales forecast 4 months or more in advance is a difficult task.

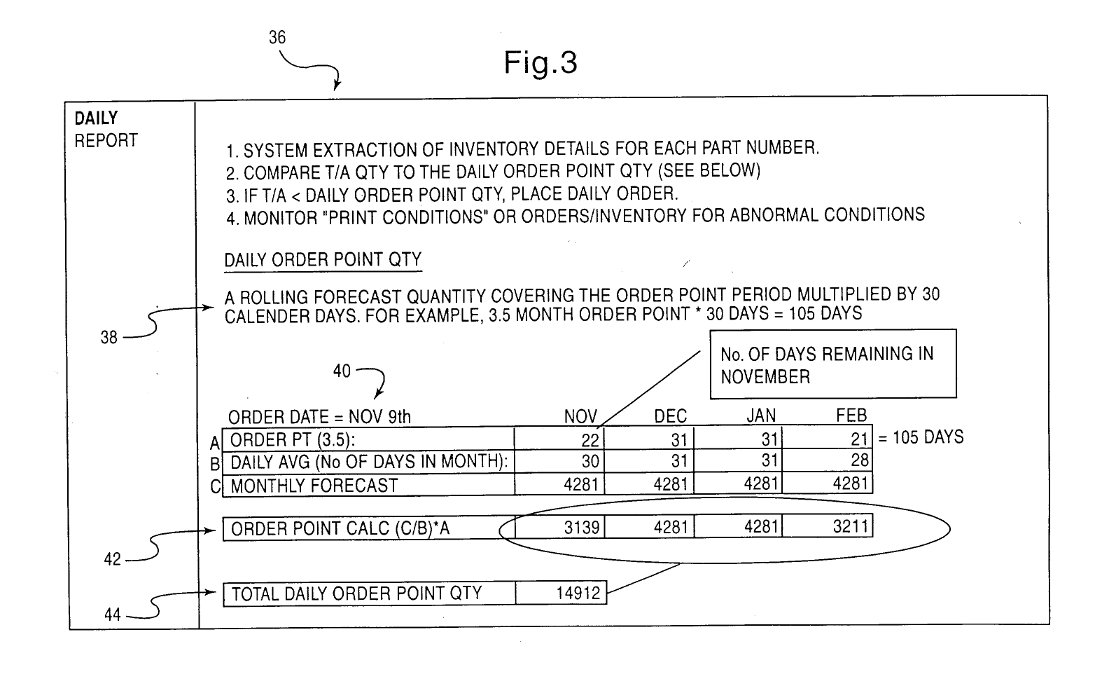

Step 30 illustrates converting the sales forecast into a running daily forecast covering a specified period of time beginning on a predetermined day. A discussion as to how the running daily forecast is generated will be described below with regard to FIG. 3. However, the running daily forecast does cover a specified period of time which may be 3 months or 4 months. The specified period of time may also be 3.5 months. Therefore, if a period of, for example, 3.5 months was to begin on November 9, then 3.5 months would extend approximately to February 21. Step 32 then generates a total daily order point of units for a specified part number based on the above running forecast. Thus, the total daily order point quantity of units represents a forecast of the total number of units, per day, to have available in order to ensure a safety stock and yet to take best advantage of the daily order method. Step 34 indicates that parts are then ordered from a supplier, wherein the quantity of parts ordered corresponds to the difference between the total daily order point quantity and the total available inventory. In other words, the total daily forecast requirement (total daily order point quantity) of units is a level which is to be desired. Thus, once parts are sold from stock in the warehouses, the total available inventory decreases. Thus, the difference between the total daily order point quantity and the total available inventory is the number of parts that is to be ordered to properly replenish those that have been sold. As illustrated below in FIGS. 3-5, the order maybe made electronically, as most parts order are made today, although parts orders may be made by telephone, by facsimile, or by hard copy. Also, since this information is also part of the database which is shared, the ordering of parts from a supplier may be accomplished automatically by the computer. In such automatic ordering, the difference described above, when calculated, is automatically sent to the suppliers as that daily parts order.

As illustrated in FIG. 3, daily report 36 illustrates the step of converting the sales forecast into a running daily forecast (step 30) and step of generating a total daily order point quantity (step 32). It should be noted that in items 2 and 3, the term “T/A” refers to total available inventory. As described at arrow 38, a rolling forecast quantity covering the order point period is multiplied by 30 days. For example, a 3.5 months order point would be obtained by multiplying 30 days×3.5. The product is 105 days (3.5 months). Therefore, as illustrated by arrow 40 beginning on an order date of November 9, 105 days would extend through February 21. As illustrated in row A, an order point of 3.5 months would show 22 days in November, 31 days in December, 31 days in January, and 21 days in February. Of course, these all add up to 105 days. Row B is provided to indicate the number of days in each month. November has 30 days, December and January have 31 days and February has 28 days. Row C illustrates the monthly forecast which is set for each month at 4281 units. The row at arrow 42 indicates the order point calculation (row C divided by row B, multiplied by row A) for each month. December and January are both at 4,281 units, since they are full months. Since November is a partial month, the order point calculation for November is 3139 units. Similarly, February is a partial month and the order point calculation is 3211 units. The total daily order point quantity illustrated at arrow 44, is 14,912, or the sum of the order point calculation for each of the months (or partial months) indicated.

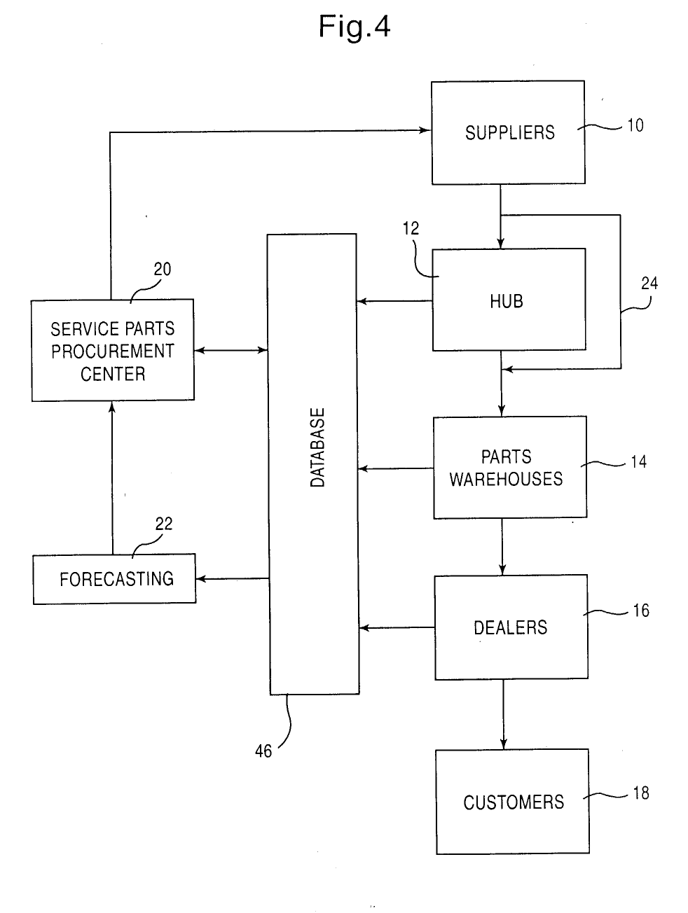

FIG. 4 illustrates the supply chain with parts traveling from suppliers 10 to hub 12 (or around hub 12 if there is no hub), through parts warehouses 14, to dealers 16, and eventually to customers 18. Shared database 46 is able to share information between the service parts procurement center 20, forecasting 22, hub 12, parts warehouses 14 and dealers 16. For example, service parts procurement center 20 obtains information about the stock on hand at the individual parts warehouses 14 by way of database 46. Since that information is available in database 46, it is not necessary for the service part procurement center 20 to poll the individual warehouses everyday as to their total available inventory. The order from the service parts procurement center 20 to the supplier or suppliers 10 may occur electronically or in any other common method. Ordering parts electronically would include direct modem connection, by the internet, by direct electronic or computer connection. Furthermore, since the difference number (between the total daily order point quantity and the total available inventory) is calculated by a computer at the service parts procurement center, the order also may be made automatically.

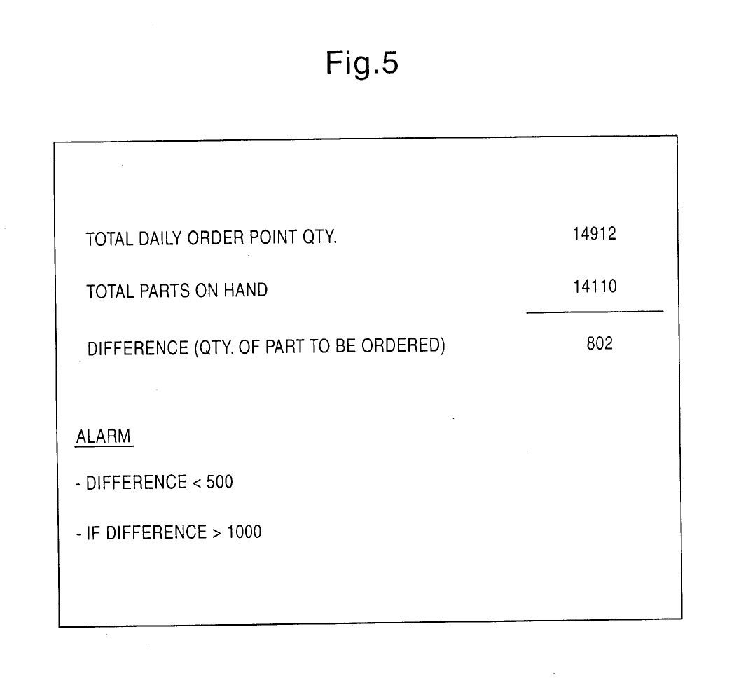

If the order is made automatically, there is a safety check to prevent any unusually large or small number from being ordered. As illustrated in the example of FIG. 5, a total daily order point quantity is set forth at 14,912 (the same as in FIG. 3). For example, supposed that the total available inventory is 14,110, then the difference (or the quantity of parts to be ordered) is 802 units. This order would be made automatically. However, if there is something unusual in the number of parts to be ordered (the difference), then an alarm would be indicated. For example, if a lower alarm limit was set as illustrated in FIG. 5 at 500 units. Then an alarm would be indicated if the difference were less than the lower limit of 500 units. Conversely, if an upper limit of 1,000 was set, then an alarm would be indicated if the difference (or quantity of parts pre-ordered) is greater than the upper level of 1,000 units. The automatic order would not be executed until the alarm has been acknowledged and corrective action taken, if any. Of course, there may be other types alarm conditions that would indicate an alarm.

1. A method for daily ordering of parts for one or more parts warehouses, comprising the steps of:
determining a specified part number and available supplier from which to place a daily parts order for the specified part number;
obtaining from each warehouse, a total available inventory for the specified part number;
preparing a sales forecast for the specified part number, wherein said sales forecast includes one or more months;
converting said sales forecast into a running daily forecast covering a specified order point period of time beginning on a predetermined day;
generating a total daily order point quantity of units for the specified part number, based on the running daily forecast; and
ordering parts, corresponding to the specified part number, from a supplier, wherein the quantity of parts ordered corresponds to the difference between the total daily order point quantity and the total available inventory.

2. The method for ordering parts of claim 1, wherein said obtaining step includes accessing a data base shared between said warehouses and a centralized parts ordering department, and extracting, from said data base, the total available inventory of the specified part number for all warehouses.

3. The method for ordering parts of claim 1, wherein said ordering step is accomplished electronically.

4. The method for ordering parts of claim 1, wherein said order point period of said running daily forecast is from about 3 months to about 4 months.

5. The method for ordering parts of claim 1, wherein order point period of said running daily forecast is about 3½ months.

6. The method for ordering parts of claim 1, wherein said method comprises ordering parts corresponding to only one part number, daily.

7. The method for ordering parts of claim 1, wherein said method comprises ordering parts corresponding to a plurality of parts numbers, daily.

8. The method for ordering parts of claim 1, wherein said total daily order point quantity is determined by totaling all monthly order points (MOPs) determined within said order point period for said running daily forecast, wherein each MOP is determined according to the following equation:
$$MOP = ( \frac{C}{B} ) \cdot A$$
wherein,
A is the number of days to be considered in a specified month,
B is the number of days in the specified month, and
C is the sales forecast for that specific month.

9. The method for ordering parts of claim 1, wherein said ordering is accomplished automatically by computer.

10. The method for ordering parts of claim 9, wherein an alarm condition occurs when said difference is outside of preset limits.

11. The method for ordering parts of claim 9, wherein said alarm condition occurs when said difference is greater than a preset upper limit.

12. The method for ordering parts of claim 9, wherein said alarm condition occurs when said difference is less than a preset lower limit.
